(19) United States
(12) Patent Application Publication
(10) Pub. No.: US 2012/0270201 A1
(43) Pub. Date: Oct. 25, 2012

(54) Dynamic User Interface for Use in an Audience Response System

(75) Inventors: Christopher M. Cacioppo, Somerville, MA (US); Brian Prendergast, Arlington, MA (US); Manuel Perez, Somerville, MA (US)

(73) Assignee: SANFORD, L.P., Oak Brook, IL (US)

(21) Appl. No.: 13/512,479

(22) PCT Filed: Nov. 30, 2010
(86) PCT No.: PCT/US2010/058269

§ 371 Date: Jul. 11, 2012

Related U.S. Application Data
(60) Provisional application No. 61/265,140, filed on Nov. 30, 2009.

(51) Int. Cl. G09B 5/04

(52) U.S. Cl. 434/351

(57) ABSTRACT

An audience response system with dynamic user interfaces and methods of using such an audience response system. The audience response system includes a wireless aggregation point and multiple remote handsets communicatively coupled to that wireless aggregation point. The remote handsets may be used (e.g., by students) to answer questions (e.g., posed by a teacher). At least some of the remote handsets may include user interfaces that include user input interface elements that are configurable via the wireless aggregation point. Additionally, the user interfaces of at least some of the remote handsets may provide feedback to the students regarding their interaction with the remote handsets.

### FIELD OF DISCLOSURE

The present disclosure relates generally to communication systems and, more particularly, to dynamic user interface for use in an audience response system.

### BACKGROUND

Audience response systems (ARS) generally provide group interaction via remote handsets. Group members may use the remote handsets to vote on topics, answer questions, etc. The remote handsets typically communicate (e.g., wirelessly using radio frequency or infrared communication technology) with one or more wireless aggregation points that generally collect and, possibly, process the data communicated by the audience via the remote handsets. The term “wireless aggregation point” is used here broadly to denote any device (or a combination of devices) that is capable of sending information to and/or receiving information from multiple remote handsets (thus making the multiple remote handsets capable of operating simultaneously, or substantially simultaneously). Examples of a wireless aggregation point include a base stations, RF USB/Serial dongles, IR USB/Serial dongles, wireless access points (as per IEEE 802.11, IEEE 802.16, or other wireless communication protocols and standard), etc.

Audience response systems may be used for a variety of purposes. For example, audience response systems may be used by teachers in a classroom setting to take attendance, administer tests and quizzes, take surveys, etc., and studies indicate that there are various benefits to using audience response systems in such a setting. For instance, audience response systems reduce the effect of crowd psychology because, unlike hand raising, audience response systems may prevent students from seeing the answers of other students. For similar reasons, audience response systems may reduce instances of cheating in the classroom. Furthermore, audience response systems typically allow faster tabulation and display of answers and a more efficient tracking of individual responses and other data (e.g., response times of individual students). Additionally, audience response systems in classrooms have been shown to improve attentiveness, increase knowledge retention and generally create a more enjoyable classroom environment and a more positive learning experience.

One challenge associated with designing audience response systems is optimizing the user interfaces of the remote handsets to provide a high degree of both usability and functionality, as the former often comes at the expense of the latter and vice versa. For example, a remote handset that is relatively small and includes only two buttons for interaction may be portable, easy to use, and suitable, for example, for Yes/No, or True/False types of questions. However, such a remote handset may have limited functionality, and it may be unsuitable, for example, for multiple choice questions. On the other hand, a remote handset that includes many buttons may function effectively in a larger variety of different interaction environments and for a wider variety of questions, but such a remote handset may be more difficult to use, more bulky, less portable, etc.

Another challenge associated with developing audience response systems is designing user interfaces for the remote handsets that provide effective feedback to the users regarding their interaction with the remote handsets. For example, it may be beneficial to indicate to the users what their options are (e.g., a set of possible answers) with respect to specific questions. Also, a user may find it useful to know whether the remote handset has registered an answer to a given question and what that registered answer is, in order to check, for example, that the registered answer is the same as the answer that user intended to provide. Additionally, in some instances (e.g., in a quiz setting), users may find it helpful to know whether their answers were correct, and if not, what is the correct answer.

### SUMMARY

The present disclosure provides audience response systems with dynamic user interfaces and methods of using such audience response system. The audience response systems include multiple remote handsets that may be used (e.g., by students in a classroom setting) to answer questions (e.g., posed by a teacher), vote on a topic, confirm attendance at an event (e.g., a lecture), and so on. The remote handsets may communicate and be communicative coupled with one or more wireless aggregation points.

At least some of the remote handsets may include user interfaces that include user input interface elements that are configurable via the wireless aggregation point. For example, when a teacher asks a student a particular question, e.g., a multiple choice question, the teacher may configure the user interface of the remote handset of that student to display a particular set of possible answers to the question and let the student choose one or more of the answers. Likewise, the teacher may configure other parameters via the wireless aggregation point, such as the maximum time given to the student for answering the question, the maximum number of allowable attempts at answering the question, etc.

Additionally, the user interfaces of at least some of the remote handsets may provide feedback to the students regarding their interaction with the remote handsets. This may be done using a variety of different indicators (e.g., visual indicators). For example, user interfaces may provide the user with various visual indications regarding the available options with respect to a particular question, the answer that the remote handset has registered for that question, whether the answer to a particular question was correct, and so on.

In one embodiment, an audience response system includes a wireless aggregation point and multiple remote handsets communicatively coupled to the wireless aggregation point. Each of the multiple remote handsets has a user interface. The user interface includes multiple configurable user input interface elements. The user interface is configured to provide a user, via the multiple configurable user input interface elements, with multiple possible answers to a question. Each of the multiple possible answers corresponds to a different configurable user input interface element. The multiple possible answers corresponding to the multiple configurable user input interface elements are configured via the wireless aggregation point. The user interface is further configured to receive from the user, via the multiple configurable user input interface elements, a selection of one or more answers from the multiple possible answers.

In another embodiment, an audience response system includes a wireless aggregation point and multiple remote handsets communicatively coupled to the wireless aggregation point. Each of the multiple remote handsets has a user interface. The user interface includes multiple user input interface elements. The user interface is configured to provide a user, via the multiple user input interface elements, with multiple possible answers to a question. Each possible answer corresponds to a different user input interface element. The user interface is further configured to provide the user, via the multiple user input interface elements, with an indication of which of the multiple possible answers are selectable and an indication of which of the multiple possible answers have been selected by the user.

In another embodiment, an audience response system includes a wireless aggregation point and multiple remote handsets communicatively coupled to the wireless aggregation point. Each of the multiple remote handsets has a user interface. The user interface includes multiple user input interface elements. Each of the multiple user input interface elements may operate in at least two operational states based on whether the respective user input interface element is selectable by a user and/or based on whether the respective user input interface element has been selected by the user. Each of the multiple input interface elements is configured to provide the user with an indication of an operational state of the respective interface element.

In another embodiment, an audience response system includes a wireless aggregation point and multiple remote handsets communicatively coupled to the wireless aggregation point. Each of the multiple remote handsets has a user interface including a touchscreen. The user interface is configured to provide multiple icons via the touchscreen. The icons are configurable via the wireless aggregation point. The user interface is further configured to provide a user, via the multiple icons, with multiple possible answers to a question. Each answer corresponds to a different icon. The user interface is further configured to receive from the user, via the multiple icons, a selection of one or more answers from the multiple possible answers.

In another embodiment, a method of interacting with an audience using an audience response system is provided. The audience response system includes a wireless aggregation point and multiple remote handsets communicatively coupled to the wireless aggregation point. Each remote handset has a user interface. The user interface includes multiple configurable user input interface elements. The method includes selecting multiple possible answers to a question. The method further includes configuring the multiple configurable user input interface elements of a given remote handset via the wireless aggregation point. Configuring the multiple configurable user input interface elements of the given remote handset includes associating each possible answer with a different configurable user input interface element of the given remote handset. The method further includes providing a user of the given remote handset, via the multiple configurable user input interface elements of the given remote handset, with the multiple possible answers. The method further includes receiving from the user, via the multiple configurable user input interface elements, a selection of one or more answers from the multiple possible answers.

In another embodiment, a method of interacting with an audience using an audience response system is provided. The audience response system includes a wireless aggregation point and multiple remote handsets communicatively coupled to the wireless aggregation point. Each remote handset has a user interface. The user interface includes multiple user input interface elements. The method includes providing a user of a given remote handset, via the multiple user input interface elements of the given remote handset, with multiple possible answers to a question. Each possible answer corresponds to a different user input interface element of the given remote handset. The method further includes providing the user of the given remote handset, via the multiple user input interface elements, with an indication of which of the multiple possible answers are selectable and an indication of which one or more of the multiple possible answers has been selected by the user. The method further includes receiving from the user, via the multiple user input interface elements, a selection of one or more answers from the multiple possible answers.

In another embodiment, an audience response system includes multiple remote handsets that are capable of operating simultaneously. Each of the multiple remote handsets has a user interface. The user interface includes multiple configurable user input interface elements. The user interface is configured to provide a user, via the multiple configurable user input interface elements, with a set of possible answers to a question, where each of the possible answers in the set corresponds to a different one of the multiple configurable user input interface elements, and where the possible answers corresponding to the multiple configurable user input interface elements are configured via an entity other than the respective remote handset. The user interface is further configured to receive from the user, via the multiple configurable user input interface elements, a selection of one or more answers from the set of possible answers.

### BRIEF DESCRIPTION OF THE DRAWINGS

FIG. 1 illustrates and example audience response system with dynamic user interfaces;

FIG. 2 illustrate an example dynamic user interface that includes buttons;

FIG. 3 illustrate another example dynamic user interface that includes buttons;

FIG. 4 illustrate an example dynamic user interface that includes icons;

FIG. 5 illustrate another example dynamic user interface that includes icons;

FIG. 6A illustrates an example dynamic user interface with user input interface elements associated with spatial regions;

FIG. 6B illustrates another example dynamic user interface with user input interface elements associated with spatial regions;

FIG. 7 is a block diagram of an example architecture of a remote handset;

FIG. 8 is a flow diagram illustrating an example method for interacting with an audience using an audience response system; and

FIG. 9 is a flow diagram illustrating another example method for interacting with an audience using an audience response system.

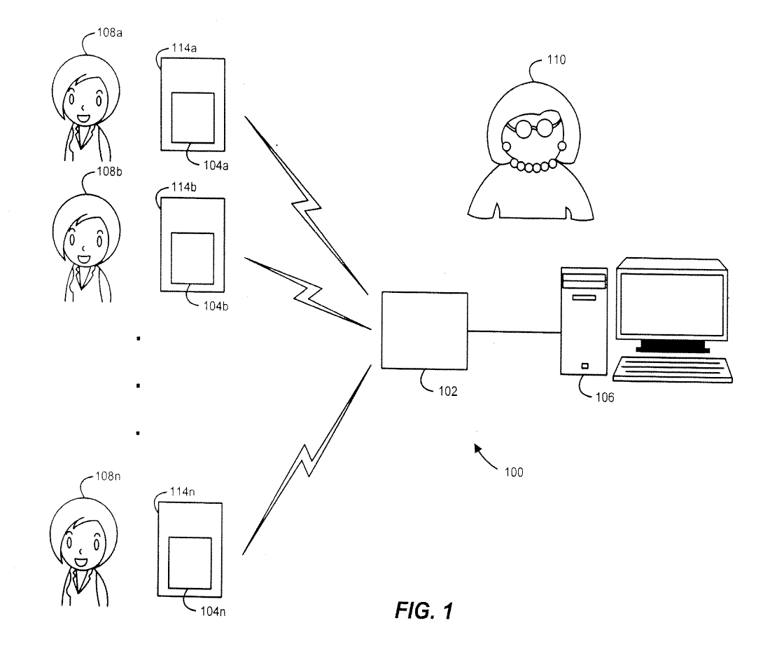

Like reference numbers and designations in the various drawings indicate like elements. Furthermore, when individual elements are designated by references numbers in the form Nn, these elements may be referred to collectively by N. For example, FIG. 1 illustrates remote handsets 114a, 114b, . . . , 104n that may be referred to collectively as remote handsets 114.

### DETAILED DESCRIPTION

### Overview of an Example Audience Response System

FIG. 1 illustrates an example audience response system (ARS) 100 with dynamic user interfaces. For ease of explanation, various components of the audience response system 100 (and similar systems) will be described in the context of a classroom environment, where a teacher may interact with one or more students using the audience response system 100. However, it will be understood by one of ordinary skill in the art that the audience response system 100, as well as individual components of the audience response system 100, may be used in other settings (e.g., corporate training, focus groups, and so on).

The ARS 100 includes multiple remote handsets 114 that may be used (e.g., by students 108) to answer questions (e.g., posed by a teacher 110), vote on a topic, confirm attendance at an event (e.g., a lecture), and so on. The remote handsets 114 may communicate wirelessly (e.g., using radio frequency (RF) or infrared (IR) communication technology) and be communicatively coupled with one or more wireless aggregation points 102. In some embodiments, the wireless aggregation point 102 may be communicatively coupled to a computer 106. As will be subsequently explained in more detail, at least some of the remote handsets 114 may include user interfaces 104 with user input interface elements that are configurable via the wireless aggregation point 102. For example, when a teacher 110 asks a student 108 (or multiple students 108) a particular question, e.g., a multiple choice question, the teacher 110 may use the computer 106, or the wireless aggregation point 102, or both, to configure the user interface 104 of the remote handset of that student 108 (or students 108) to display a particular set of possible answers to the question and permit the student 108 pick one or more of the answers. Likewise, the teacher 110 may configure other parameters via the wireless aggregation point 102, such as the maximum time given to the student to answer the question, the maximum number of allowable attempts at answering the question, etc.

Additionally, as will be subsequently explained in more detail, the user interfaces 104 of at least some of the remote handsets 114 may provide feedback to the students regarding their interaction with the remote handsets 114. This may be done using a variety of different indicators (e.g., visual indicators). For example, user interfaces 104 may provide the user with various indications regarding the available options with respect to a particular question, the answer that the remote handset has registered for that question, whether the answer to a particular question was correct, and so on.

### User Interfaces with Configurable Input User Interface Elements

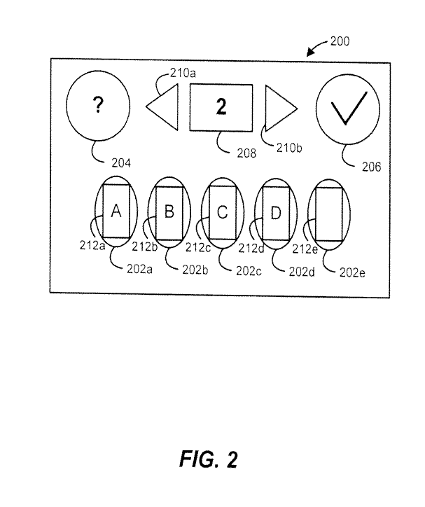

FIGS. 2-6B illustrate example dynamic user interfaces 200, 300, 400, 500, 600 that may be included as user interfaces 104 in the remote handsets 114 of the ARS 100 illustrated in FIG. 1. It will be understood, however, that the dynamic user interfaces 200, 300, 400, 500, 600 may also be included in remote handsets other that those illustrated in FIG. 1.

As illustrated in FIGS. 2-6B, the dynamic user interfaces 200, 300, 400, 500, 600 may include multiple configurable user input interface elements 202, 302, 402, 502, 602 for answering the various questions presented in an audience interaction environment such as a classroom. In some embodiments, when a teacher poses a question to the students, the teacher may configure these configurable user input interface elements 202, 302, 402, 502, 602 to correspond to the possible answers to that question. A student may then answer the question by selecting the appropriate configurable user input interface element 202, 302, 402, 502, 602.

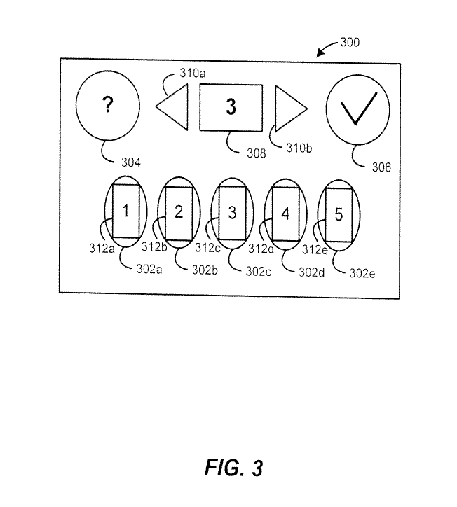

In some embodiments, as illustrated in FIGS. 2-3, the configurable user input interface elements 202, 302 may be configurable buttons. The term “button” as used herein refers broadly to any type of a switch mechanism (e.g., electrical or mechanical). For example the configurable buttons 202, 302 may include any types of pushbuttons, actuators, toggle switches, key switches, heat of pressure-sensitive surfaces, and so on.

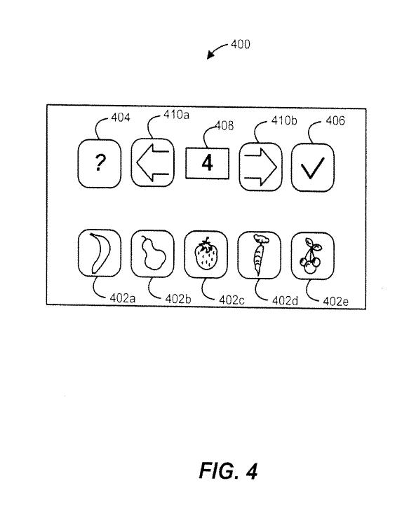

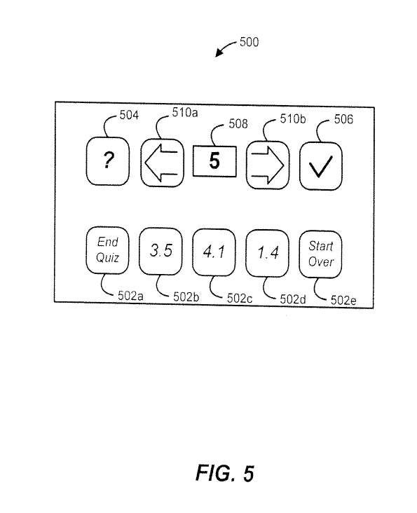

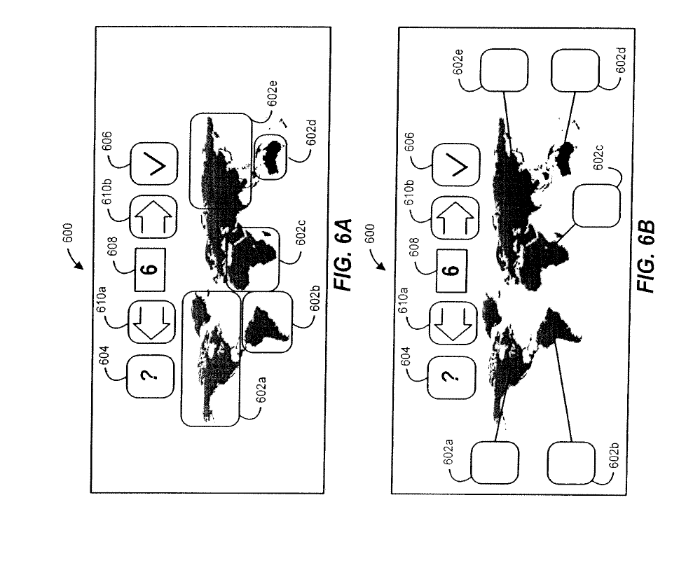

In other embodiments, as illustrated in FIGS. 4-5, for instance, the configurable user input interface elements 402, 502 may be icons on a screen. For example, a remote handset 114 may include a touchscreen (e.g., a capacitive screen or a resistive screen), and the configurable user input interface elements 402, 502 may be configurable icons that may be selected by touch, using a stylus, etc. However, in some embodiments, the icons may also be selected via an input devices such as a track ball, a scroll wheel, a mouse, a joystick and so on, so a touchscreen is not required for the configurable user input interface elements 402, 502 to be icons. Additionally, or alternatively, as illustrated in FIGS. 6A-6B, for instance, the configurable user input interface elements 602 may be interface elements associated with spatial regions on a screen.

The user input interface elements 202, 302, 402, 502, 602 illustrated in FIG. 2-6B may include indicators (e.g., visual indicators) of the possible answers associated with the configurable user input interface elements 202, 302, 402, 502, 602. In some embodiments, as illustrated in FIGS. 2-3, the configurable user input interface elements 202, 302 may include displays 212, 312, such as liquid crystal displays (LCD), e.g., 5×7 LCD display, light emitting diode (LED) displays, e.g., 5×8 LED matrix displays, or any other suitable displays for displaying the visual indicators of the answers associated with the configurable user input interface elements 202, 302. In other embodiments, as illustrated in FIGS. 4-6B, the display functionality described above may be inherent to the configurable user input interface elements 402, 502 (e.g., if the configurable user input interface elements 402, 502, 602 are icons, or spatial regions of a graphic on a screen).

The configurable user input interface elements 202, 302, 402, 502, 602 may be configured to display a variety of different types of answers. For example, as illustrated in FIG. 2, for a multiple choice question, the configurable user input interface elements 202 may be configured to display letters (e.g., “A,” “B,” “C” and “D”) associated with multiple answer choices. Likewise, as illustrated in FIG. 3, the configurable user input interface elements 302 may be configured to display letters (e.g., “1,” “2,” “3,” “4” and “5”) associated with multiple answer choices. It should be noted that, as illustrated in FIG. 2, for example, there may be fewer answer choices than configurable user input interface elements 202. As a result, there may be at least one configurable user input interface element 202e that does not correspond to any answer choices. As will be subsequently described in more details, such configurable user input interface elements 202e may be disabled (e.g., put in an unavailable, or unselectable state). The configurable user input interface elements 202e that does not correspond to any answer choices may also be configured for purposes other that to display, and to enable a user to select, an answer choice.

In some embodiments, as illustrated in FIGS. 4-5, the configurable user input interface elements 402, 502 may be configured to display the answer choices themselves. For instance, as illustrated in FIG. 4, the configurable user input interface elements 402 may be configured to display images associated with multiple answer choices. For example, if a teacher shows the students a banana, a pear, a strawberry, a carrot and a cherry and asks the students to identify which of the above is a vegetable, the configurable user input interface elements 402 may be configured to display images of a banana, a pear, a strawberry, a carrot and a cherry. As illustrated in FIG. 5, the configurable user input interface elements 502 may also be configured to display multiple numerical answer choices. For instance, if a teacher asks the students to add 1.2 and 2.3, the configurable user input interface elements 502 may also be configured to display multiple choices for the answer (e.g., “3.5,” “4.1” and “1.4”).

In some embodiments, as illustrated in FIGS. 6A-6B, the configurable user input interface elements 602 may be configured to display answer choices as spatial regions on a user interface 600 (e.g., spatial regions on a screen associated with the user interface 600). For instance, the configurable user input interface elements 602 may be configured to correspond to different spatial regions of an image, or images, displayed on the screen. For example, if a teacher asks the students to identify Asia on a world map, the user interface 600 of the handsets may be configured to display an image of the world map, and the configurable user input interface elements 602 on the user interface 600 may be configured to correspond to different spatial regions on the displayed image (e.g., each region associated with a different continent). Students may respond by selecting that appropriate spatial region of the image.

The configurable user input interface elements 602 may be configured to correspond to different spatial regions on the displayed image in a variety of ways. For example, as illustrated in FIG. 6A, the configurable user input interface elements 602 may enclose the different spatial regions. Alternatively, as illustrated in FIG. 6B, for instance, the configurable user input interface elements may be icons that reference (e.g., point to) to the different spatial regions of the image. Therefore, in general, the configurability of the configurable user input interface elements 602 is not limited to the configurability of particular answer choices associated with each configurable user input interface element 602. Rather, the configurable user input interface elements 602 may also be configured (e.g., by a teacher) to have different shapes, sizes, positions on the user interface 600, and so on.

It will be appreciated by one of ordinary skill in the art that the configurable user input interface elements 202, 302, 402, 502, 602 may be configured to display various other types of answer choices. For example, the configurable user input interface elements 202, 302, 402, 502, 602 may be configured to display symbols, special characters, foreign language characters, and so on.

Furthermore, as already mentioned, some of the configurable user input interface elements 202, 302, 402, 502, 602 may be configured for purposes other that to display, and to enable a user to select, an answer choice. For example, as illustrated in FIG. 5, if a question has fewer answer choices than available configurable user input interface elements 502 on a remote handset, those configurable user input interface elements 502a, 502e that do not correspond to any answer choices may be configured to perform a variety of other functions. For instance, if a student is using a remote handset to answer a series of questions, e.g., as part of a quiz, those configurable user input interface elements 502a, 502e that do not correspond to any answer choices may be configured to enable the student to end the quiz (e.g., if all the questions have been answered), to start the quiz over, to move to the next question, to go back to a previous question, and so on).

In various embodiments, or in various modes of operation, the user interfaces 200, 300, 400, 500, 600 of remote handsets may include a variety of other configurable or non-configurable user input interface elements. For example, the user interfaces 200, 300, 400, 500, 600 may include one or more user input interface elements 204, 304, 404, 504, 604 for soliciting help (e.g., from a teacher), one or more user input interface elements 206, 306, 406, 506, 606 for confirming a selected answer choice, etc. The user interfaces 200, 300, 400, 500, 600 may also include one or more user input interface elements for configuring the respective remote handsets. For example, in some embodiments, each remote handset may have a unique identification number, and the interfaces 200, 300, 400, 500, 600 may include separate user input interface elements 210, 310, 410, 510, 610 for configuring (e.g., incrementing) the respective identification numbers. Likewise, some remote handsets may include separate interface elements 208, 308, 408, 508, 608 for displaying the respective identification numbers.

One of ordinary skill in the art will understand that various other types of user input interface elements may be included in the user interfaces 200, 300, 400, 500, 600 that, for ease of explanation, are not shown in FIGS. 2-6B. Moreover, it will be understood that various combinations of configurable and non-configurable user input interface elements may be included in the user interfaces 200, 300, 400, 500, 600. In particular, although the configurable user input interface elements 202, 302, 402, 502, 602 discussed in reference to FIGS. 2-6, such as configurable buttons 202, 302, icons 402, 502 and spatial regions 602 have all been described as configurable for ease of explanation, it will be appreciated that at least some of the user input interface elements 202, 302, 402, 502, 602 may be non-configurable, preconfigured, etc.

Moreover, the user input interface elements 202, 302, 402, 502, 602 that are configurable may be configured by a variety of entities. For example, the configurable user input interface elements 202, 302, 402, 502, 602 may be configured manually, e.g., by a teacher. Additionally, or alternatively, the configurable user input interface elements 202, 302, 402, 502, 602 may be configured, or preconfigured, automatically, e.g., by a computer program. For instance, a teacher may upload a computer program to the handsets 114 that includes a quiz. The computer program may configure the handsets 114 to provide a series of quiz questions and automatically configure the user input interface elements 202, 302, 402, 502, 602 with a set of possible answer choices for each quiz question.

### Feedback Regarding Interaction with a Remote Handset

Referring again to FIG. 1, the user interfaces 104 (such as user interfaces 200, 300, 400, 500, 600 described in reference to FIGS. 2-6B) of at least some of the remote handsets 114 may provide feedback to students regarding their interaction with the remote handsets 114 using a variety of different indicators (e.g., visual indicators). For example, such user interfaces 104 may provide students with various indications regarding the available options with respect to a particular question (e.g., a set of possible answers), the answer that the remote handset has registered for that question, whether the answer to a particular question was correct, and so on.

More specifically, the various user input interface elements (configurable or non-configurable) described above in reference to FIGS. 2-6B may operate in different operational states, and a given interface element may provide an indication (e.g., a visual indication) of the operational state of that interface element to the user. For example, a user input interface element, such as a button (e.g., similar to the configurable buttons 202, 302 described in reference to FIGS. 2-3), icon (e.g., similar to the configurable icons 402, 502 described in reference to FIGS. 4-5), or spatial regions (e.g., similar to the configurable spatial regions 602 described in reference to FIGS. 6A-6B) may operate in different states based on whether that user input interface element is selectable (e.g., not disabled). Additionally, or alternatively, a user input interface element may operate in different states based on whether the user has already selected that user input interface element (e.g., in response to a multiple choice question, as describe above).

In some embodiments, a user input interface element may operate in a SELECTABLE state and/or in an UNSELECTABLE state. Generally, if a user input interface element operates in a SELECTABLE state, the user input interface element is selectable (i.e., the user input interface element may be selected by the user), and if a user input interface element operates in an UNSELECTABLE state, the user input interface element is not selectable (i.e., the user input interface element may not be selected by the user).

A user input interface element may operate in a SELECTABLE state for a number of reasons and under a variety of circumstances. For example, in a classroom environment described in reference to FIG. 1, in which students 108 respond to questions using remote handsets 114, a user input interface element (e.g., a button or an icon) on a remote handset may operate in an UNSELECTABLE state if there are no outstanding questions, if all questions have been answered, if a time limit to answer a question has expired, and so on. Also, as illustrated in FIG. 2, for example, a user input interface element 202e may operate in an UNSELECTABLE state if there is an outstanding question, but if the particular user input interface element 202e does not correspond to any possible answer choices. Additionally, in some embodiments, even if there is an outstanding question and a given user input interface element corresponds to an answer choice, that user input interface element may still operate in an UNSELECTABLE state if, for example, a different user input interface element (e.g., corresponding to a different answer choice) has already been selected (and if students are not allowed to change their answers).

A user input interface element may also operate in a SELECTABLE state for a number of reasons and under a variety of circumstances. For example, in a classroom environment described in reference to FIG. 1, a user input interface element on a user interface of a remote handset may operate in a SELECTABLE state if there is an outstanding question that has not been answered and the user input interface element corresponds to one of the possible answer choices. In some embodiments, even if a question has been answered (e.g., a different user input interface element corresponding to a different answer choice has already been selected), the user input interface element may nonetheless operate in a SELECTABLE state. For example, in an environment where students are allowed to change their answers, if a student has already selected one user input interface element corresponding to one answer choice, other user input interface elements corresponding to other answer choices may still operate in a SELECTABLE state to allow the student to choose a different answer choice.

In some embodiments, a user input interface element may further operate in a SELECTED state and in and UNSELECTED state. Generally, if a user input interface element operates in a SELECTED state, that user input interface element has been selected by the user (e.g., in response to a question), and if a user input interface element operates in an UNSELECTED state, that user input interface element has not been selected by the user.

A user input interface element may operate in a SELECTED state for a number of reasons and under a variety of circumstances. In some embodiments, a user input interface element operating in a SELECTED state may not be selectable. For example, if a student selected the user input interface element in response to a question, the user may no longer unselect it. In other embodiments, however, a user input interface element operating in a SELECTED state may be selectable. That is, for instance, if a student has already selected the user input interface element in response to a question, but the student decides to withdraw the answer choice associated with that user input interface element, the student may be able to select that user input interface element again to effectively unselect that user input interface element. The student may then select a different user input interface element corresponding to a different answer choice. Furthermore, in some embodiments, the student may select a different user input interface element corresponding to a different answer choice without explicitly unselecting the previously selected user input interface element (corresponding to the previously selected answer choice). In these embodiments, the previously selected user input interface element may no longer operate in a SELECTED state once a different user input interface element is selected by the student.

A user input interface element may also operate in a UNSELECTED state for a number of reasons and under a variety of circumstances. For example, a user input interface element may also operate in a UNSELECTED state if the user input interface element corresponds to one of the answer choices to an outstanding questions, but that answer choice has not been selected. In other embodiments, the user input interface element may also operate in a UNSELECTED state even if the user input interface element does not correspond to one of the answer choices to an outstanding question. For example, as explained in reference to FIG. 5, some user input interface elements 502a, 502e may be configured for purposes other than displaying answer choices (and enabling students to select those answer choices), e.g., to enable a student to move back and forth between different questions, start a quiz over, to end a quiz, etc. Such user input interface elements 502a, 502e, while not corresponding to any answer choices, may nonetheless operate in an UNSELECTED state.

In some embodiments, a user input interface element may operate in a combination of different operational states described above. For example, if there is an outstanding question that has not been answered, an interface element corresponding to one of the answer choices to the outstanding question may operate in an UNSELECTED-SELECTABLE state. Similarly, if a user input interface element has been selected for a particular question, that user input interface element may operate in a SELECTED-UNSELECTABLE state (e.g., in an environment where students are not allowed to change their answers) or in a SELECTED-SELECTABLE (e.g., in an environment where students are allowed to change their answers). As another example, if there is an outstanding question, but a user input interface element does not correspond to an answer choice, the user input interface element may operate in an UNSELECTED-UNSELECTABLE state. It will be understood by one of ordinary skill in the art that user input interface elements may operate in various other combinations of operational states.

In some embodiments, the operational state of a given user input interface element may be indicated to the user (e.g., a student), via the user input interface element itself, e.g., using a visual indication. For example, a user input interface element may be illuminated with different colors, brightness levels, flashing (or steady-lit) patterns, etc., and the different colors, brightness levels, flashing (or steady-lit) patterns, etc. may provide the user with an indication of the operational state of the user input interface element.

For instance, if a question is asked and a given user input interface element corresponds to one of the possible answer choices, that user input interface element may be operating in an UNSELECTED-SELECTABLE state and be illuminated with one color (e.g., red). If the user input interface element is then selected by the student, the user input interface element may transition into a SELECTED-SELECTABLE state (e.g., if students are allowed to change their answers) or into a SELECTED-UNSELECTABLE state (e.g., if students are not allowed to change their answers). As a result of this transition in the operational state, the user input interface element may be illuminated by a different color (e.g., red) to indicate a transition.

In some embodiments, operational states (and transitions between operational states) of a user input interface element may be communicated to a student using brightness levels of the user input interface element. For instance, if a question is asked and various user input interface elements correspond to various possible answer choices, the various interface element may be operating in an UNSELECTED-SELECTABLE state and be illuminated with the same level or brightness. Once one of the user input interface elements selected by the student, the selected user input interface element may transition into a SELECTED state. As a result of this transition in the operational state, the selected user input interface element may become brighter. Additionally, or alternatively, the other user input interface elements may become dimmer or turn off entirely (e.g., depending on whether or not the students are allowed to change their answers).

In other embodiments or modes of operations, various other visual indicators may be used indicate the operation states (and transitions between operational states) of user input interface elements to a student. For example, various flashing effects may be used. As one example, if a question is asked and various user input interface elements correspond to various possible answer choices, the various interface elements may flash to indicate that the user input interface elements are operating in a SELECTABLE state. Once one of the user input interface elements selected by the student, the selected user input interface element may stop flashing, and remain steady-lit, to indicate a transition into a SELECTED state. Additionally, or alternatively, the other user input interface elements may turn off (e.g., if the students are not allowed to change their answers).

The user input interface elements may be illuminated with different colors, brightness levels, flashing patterns, etc. in a variety of ways. For example, if a user input interface element is a button 202, 302, as described in reference to FIGS. 2-3, the button may be illuminated with different colors, brightness levels, flashing patterns, etc. using LEDs on the display 212, 312 associated with the button 202, 302. If a user input interface element is an icon 402, 502, or a spatial region 602 on a screen, as described in reference to FIGS. 4-6B, the icon and/or spatial regions may be highlighted on the screen with different colors, brightness levels, flashing patterns, etc.

The various indicators of operational states of the user input interface elements (such as the visual indicator described above), may provide the student with information regarding the operating of the remote handset. In particular, the colors, brightness levels, flashing pattern, etc. of user input interface elements may provide students with an indication of which answer choices are possible for a given question and which answer choice has been selected by the student. These indicators may also communicate other information to the students, such as whether the students are allowed to change answers, move between questions, and so on.

### Example Remote Handset Architecture and Method of Use

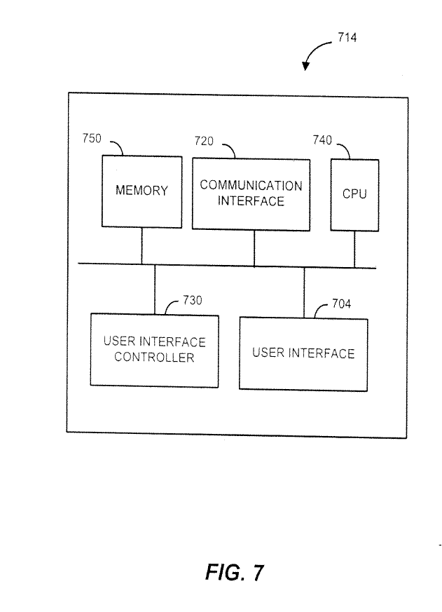

FIG. 7 is a block diagram of an example architecture of a remote handset 714. The example remote handset 714 may be utilized in the ARS 100 illustrated in FIG. 1 as a remote handset 114. It will be understood, however, that the remote handset 714 may be alternatively used in other audience response systems.

In addition to the user interface 704, the remote handset 714 may include a number of units, or components. For example, the remote handset 714 may include a communication interface 720 for generally communicating with one or more wireless aggregation points. The remote handset 714 may also include a user interface controller 730 for controlling the dynamic user interface 704. The remote handset 700 may further include a central processing unit (CPU) 740 coupled to the user interface controller 730. The CPU 740 may execute computer readable instructions stored in a memory 750 coupled to the CPU 740.

It should be understood that the remote handset 700, in some embodiments, or in some modes of operation, may not include one or more of the units 720, 730, 740, 750 described above or, alternatively, may not use each of the units 720, 730, 740, 750. Furthermore, it will be appreciated that, if desired, some of the units 620, 630, 640, 650 may be combined, or divided into distinct units.

The functionality of the remote handset 700 may be implemented with or in software programs or instructions and/or integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

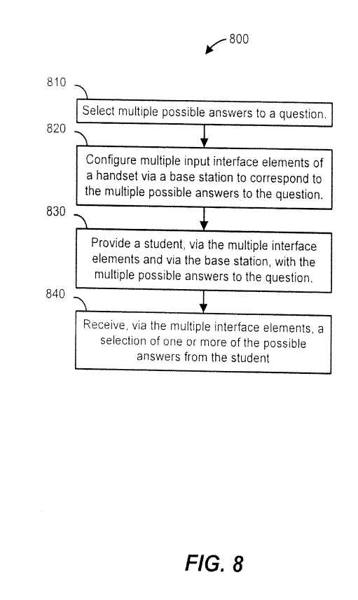

FIG. 8 is a flow diagram illustrating an example method 800 for interacting with an audience (e.g., a student) using an audience response system and remote handsets such as those discussed in reference to FIGS. 1-7. In particular the example method 800 for interacting with an audience may be used with an audience response system that includes a wireless aggregation point (such as the wireless aggregation point 102 illustrated in FIG. 1) and multiple remote handsets (such as remote handsets 114 illustrated in FIG. 1) that have a dynamic user interface (such as the dynamic user interfaces 200, 300, 400, 500, 600 illustrated in FIGS. 2-6B) with configurable user input elements (such as buttons 202, 302 illustrated in FIGS. 2-3, icons 402, 502 illustrated in FIGS. 4-5, or spatial regions 602 illustrated in FIGS. 6A-6B). For ease of explanation, FIG. 8 will be described with reference to FIGS. 1-7. It is noted, however, that the method 800 may be utilized with systems and devices other than those illustrated in FIGS. 1-7.

In some embodiments, when a teacher (or another presenter) poses a question to the students, the teacher may select multiple possible answers to that question (block 710). The teacher may then configure the configurable user input interface elements (such as the configurable buttons 202, 302, illustrated in FIGS. 2-3, configurable icons illustrated in FIGS. 4-5, and/or spatial regions illustrated in FIGS. 6A-6B) of the remote handsets via the wireless aggregation point (block 820). Configuring the configurable user input interface elements may include associating each of the of possible answers with a different configurable user input interface element of a given remote handset. Once the configurable user input interface elements are configured, each student may be effectively provided, via the configurable user input interface elements, with the multiple possible answers (block 830). That is, the students may be provided, via the configurable user input interface elements, with an indication (e.g., a visual indication) of which answer choices are available. The students may select one or more of the multiple possible answers by selecting the corresponding one or more user input interface elements. Optionally, the students may be allowed to confirm their answers, and the selections of the students may be received from the students (block 840), e.g., at the wireless aggregation point.

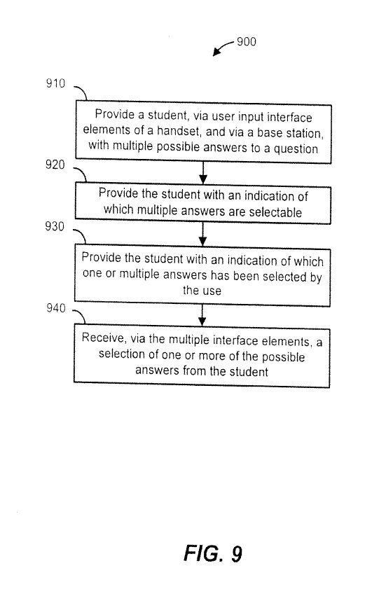

FIG. 9 is a flow diagram illustrating an example method 900 for interacting with an audience (e.g., a student) using an audience response system and remote handsets such as those discussed in reference to FIGS. 1-7. In particular the example method 900 for interacting with an audience may be used with an audience response system that includes a wireless aggregation point (such as the wireless aggregation point 102 illustrated in FIG. 1) and multiple remote handsets (such as remote handsets 114 illustrated in FIG. 1) that have a dynamic user interface (such as the dynamic user interfaces 200, 300, 400, 500, 600 illustrated in FIGS. 2-6B) with configurable user input elements (such as buttons 202, 302 illustrated in FIGS. 2-3, icons 402, 502 illustrated in FIGS. 4-5, or spatial regions 602 illustrated in FIGS. 6A-6B). For ease of explanation, FIG. 9 will be described with reference to FIGS. 1-7. It is noted, however, that the method 900 may be utilized with systems and devices other than those illustrated in FIGS. 1-7.

In some embodiments, when a teacher (or another presenter) poses a question to the students, each student may be provided with, via the user input interface elements (such as the buttons 202, 302, illustrated in FIGS. 2-3, icons 402, 502 illustrated in FIGS. 4-5, and/or spatial regions 602 illustrated in FIGS. 6A-6B) of the remote handsets, and via the wireless aggregation point, multiple possible answers to the question (block 910). Each of the possible answers may correspond to a different user input interface element. The students may also be provided with, via the user input interface elements, an indication of which multiple possible answers are selectable (block 920) and an indication of which one or more possible answers has been selected by the student (block 930). This may be done in a variety of ways, as explained, for example in the section of the present disclosure entitled “Feedback regarding Interaction with a Remote handset.” The students may select one or more of the multiple possible answers by selecting the corresponding one or more user input interface elements. Optionally, the students may be allowed to confirm their answers, and the students' selections may be received from the students (block 940), e.g., at the wireless aggregation point.

Different components of audience response systems described in this disclosure may be implemented in digital electronic circuitry, or in computer software, firmware, or hardware, including the structural means disclosed in this specification and structural equivalents thereof, or in combinations of them. These components may be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) may be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, such as the methods 800, 900 illustrated in FIGS. 8-9, may be performed by one or more programmable processors executing one or more computer programs by operating on input data and generating output. The processes and logic flows can also be performed by, and apparatus disclosed herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Different components of audience response systems have been described in terms of particular embodiments, but other embodiments can be implemented and are within the scope of the following claims.

1-16. (canceled)

17. An audience response system comprising:
a wireless aggregation point; and
a plurality of remote handsets communicatively coupled to the wireless aggregation point, each of the plurality of remote handsets having a user interface, the user interface comprising a plurality of user input interface elements, the user interface configured to:
provide a user, via the plurality of user input interface elements, with a plurality of possible answers to a question, wherein each of the plurality of possible answers corresponds to a different one of the plurality of user input interface elements; and
provide the user, via the plurality of user input interface elements, with an indication of which of the plurality of possible answers are selectable and an indication of which of the plurality of possible answers have been selected by the user, wherein each of the plurality of user input interface elements may operate in at least two operational states based on at least one of:
whether the respective user input interface element is selectable; and
whether the respective user input interface element has been selected by the user; and wherein each of the plurality of user input interface elements is configured to provide the user with an indication of an operational state of the respective user input interface element.

18. The audience response system of claim 17, wherein the user interface is configured to provide the user via the plurality of user input interface elements with the indication of which of the plurality of possible answers are selectable and the indication of which of the plurality of possible answers have been selected by the user by providing the user with an indication of an operational state of at least one the plurality of user input interface elements.

19. The audience response system of claim 17, wherein the indication of an operational state of a given user input interface element is a visual indication.

20. The audience response system of claim 17, wherein the indication of an operational state of a given user input interface element is related to a color of the given interface element.

21. The audience response system of claim 17, wherein the indication of an operational state of a given user input interface element is related to a brightness level of the given interface element.

22. The audience response system of claim 17, wherein the indication of an operational state of a given user input interface element is related to a flashing pattern of the given interface element.

23-43. (canceled)

44. A method of interacting with an audience using an audience response system comprising a wireless aggregation point and a plurality of remote handsets communicatively coupled to the wireless aggregation point, each of the plurality of remote handsets having a user interface, the user interface comprising a plurality of user input interface elements, the method comprising:
providing a user of a given remote handset, via the plurality of user input interface elements of the given remote handset, with a plurality of possible answers to a question, wherein each of the plurality of possible answers corresponds to a different one of the plurality of user input interface elements of the given remote handset;
providing the user of the given remote handset, via the plurality of user input interface elements, with an indication of which of the plurality of possible answers are selectable and an indication of which of the plurality of possible answers have been selected by the user; and
receiving from the user via the plurality of user input interface elements a selection of one or more answers from the plurality of possible answers.

45. The method of claim 44, wherein each of the indication of which of the plurality of possible answers are selectable and the indication of which of the plurality of possible answers have been selected by the user is a visual indication.

46. The method of claim 44, wherein each of the plurality of user input interface elements may operate in at least two operational states based on at least one of:
whether the respective user input interface element is selectable; and
whether the respective user input interface element has been selected by the user.

47. The method of claim 46, wherein providing the user of the given remote handset, via the plurality of user input interface elements, with the indication of which of the plurality of possible answers are selectable and the indication of which of the plurality of possible answers have been selected by the user comprises providing the user of the given remote handset with an indication of an operational state of at least one the plurality of user input interface elements.

48. The method of claim 47, wherein the indication of an operational state of a given user input interface element is a visual indication.

49. The method of claim 47, wherein the indication of an operational state of a given user input interface element is related to a color of the given interface element.

50. The method of claim 47, wherein the indication of an operational state of a given user input interface element is related to a brightness level of the given interface element.

51. The method of claim 47, wherein the indication of an operational state of a given user input interface element is related to a flashing pattern of the given interface element.

52. The method of claim 46, wherein the at least two operational states include an UNSELECTABLE state, wherein a given user input interface element operating in the UNSELECTABLE state is not selectable.

53. The method of claim 46, wherein the at least two operational states include a SELECTABLE state, wherein a given user input interface element operating in the SELECTABLE state is selectable.

54-55. (canceled)

56. An audience response system comprising:
a wireless aggregation point; and
a plurality of remote handsets communicatively coupled to the wireless aggregation point, each of the plurality of remote handsets having a user interface, the user interface comprising a plurality of user input interface elements, wherein each of the plurality of user input interface elements may operate in at least two operational states based on at least one of whether the respective user input interface element is selectable by a user and whether the respective user input interface element has been selected by the user, and wherein each of the plurality of user input interface elements is configured to provide the user with an indication of an operational state of the respective interface element.

57. The audience response system of claim 56, wherein the indication of an operational state of a given user input interface element is a visual indication.

58. The audience response system of claim 56, wherein the indication of an operational state of a given user input interface element is related to a color of the given interface element.

59. The audience response system of claim 56, wherein the indication of an operational state of a given user input interface element is related to a brightness of the given interface element.

60-75. (canceled)
